(19) United States
(12) Patent Application Publication
(10) Pub. No.: US 2015/0261979 A1
(43) Pub. Date: Sep. 17, 2015

(54) METHOD FOR MONITORING AN ARITHMETIC UNIT

(71) Applicant: Robert Bosch GmbH, Stuttgart (DE)

(72) Inventor: Axel AUE, Korntal-Muenchingen (DE)

(21) Appl. No.: 14/658,339

(22) Filed: Mar. 16, 2015

(30) Foreign Application Priority Data
Mar. 14, 2014 (DE) 10 2014 204 835.4

(51) Int. Cl. G06F 21/87

(52) U.S. Cl. CPC G06F 21/87

(57) ABSTRACT

A method is provided for monitoring a control unit having a monolithically integrated processor arrangement including a processor unit and a security processor unit, the processor unit and the security processor unit respectively including one or multiple processor core(s) and a local memory and are designed monolithically, the processor unit carrying out different processes, the security processor unit monitoring whether the different processes carried out by the processor unit are carried out according to certain process criteria and the security processor unit carrying out a safety measure when one of the processes is not carried out according to the certain process criteria.

### FIELD OF THE INVENTION

The present invention relates to a method for monitoring an arithmetic unit having a processor unit and a security processor unit.

### BACKGROUND INFORMATION

Modern arithmetic units such as control units, for example of motor vehicles, mostly include a processor unit. In arithmetic units processes are permanently carried out by the processor unit. Such a processor unit may include an advantageous processor or processor core (core), or a multi-core processor. Multi-core processors include multiple (at least two) processor cores. A processor core includes an arithmetic logic unit (ALU) which represents the actual electronic arithmetic unit for carrying out tasks, programs, arithmetic instructions, etc., as well as a local memory. Such a local memory is in particular implemented as a register set of one or multiple registers.

Modern processor units may be operated in a so-called hypervisor mode. In this case so-called virtual systems or virtual machines are configured in the processor unit. In these individual virtual systems or machines, operating systems or applications which are in each case separated from one another may be carried out as processes. For example, a plurality of virtual processor units may be simulated in this way in one real, physical processor unit. The computing power or the efficiency of a processor unit may thus be increased in an inexpensive manner without expanding the processor unit with additional physical, real resources. Instead, the existing physical resources of the processor unit may be divided among the virtual machines or systems and may be used by these together.

It may prove to be advantageous to integrate such processor units into arithmetic units using a hypervisor mode, for example into control units for motor vehicles, such as an engine control unit. In such a case, however, it must be ensured that the safety requirements and safety standards applying for the automotive field are adhered to and that attacks and manipulation of the control unit are prevented. In particular a “know-how protection” is to be ensured and “chip tuning” is to be prevented.

In the course of the processes, which are carried out by a processor unit, in particular certain data are processed, for example, specific control instructions, technical data, control values or characteristic values. These instructions or values have been frequently ascertained and optimized by the manufacturer in years of development processes with a high level of research effort, using lengthy, complex test series. It is thus the intent of the manufacturer that these data cannot be read out by a third party (an attacker), in order to guarantee a “know-how protection.”

In the course of a “chip tuning” an attacker attempts to manipulate the processes carried out by the processor unit and to thereby modify control parameters of the control unit in order to induce increased performances. This may result in damage to components and environmental pollution, and even personal injury, since the entire vehicle design (drive, brake system) may be adversely affected.

It is thus desirable to provide an option to protect a processor unit of an arithmetic unit, in particular a control unit for a motor vehicle, from attacks and to prevent a manipulation of the processes carried out by the processor unit.

### SUMMARY

A method for monitoring an arithmetic unit is provided according to the present invention. Advantageous embodiments are the subject matter of the subclaims and the following description.

The arithmetic unit includes a monolithically integrated processor arrangement including a processor unit and a security processor unit. The processor unit and the security processor unit are designed as two separate processor units independent of one another, which, however, are monolithically integrated on the same die or (silicon) substrate. The communication between processor unit and security processor unit is thus protected in particular against external accesses. Both the processor unit as well as the security processor unit respectively include in particular one or multiple processor core(s).

Furthermore, the processor unit and the security processor unit each include in particular a local memory, for example, a flash memory, a ROM memory and/or a RAM memory, furthermore respectively in particular protection mechanisms against voltage changes, clock changes and temperature changes.

In the course of the regular operation of the arithmetic unit, the processor unit carries out different processes. The security processor unit monitors these processes carried out by the processor unit and thus the arithmetic unit.

The monitoring of the arithmetic unit or the monitoring of the processes carried out by the processor unit is thus not carried out with the aid of software or an application, which is carried out by the processor unit itself. The monitoring is carried out according to the present invention using a dedicated hardware component which is independent of the processor unit which is to be monitored. The security processor unit is thus designed as a so-called Hardware Security Module (HSM).

Since the security processor unit includes dedicated physical resources (processor core(s), local memory, etc.) and in particular dedicated protection mechanisms independent of the processor unit, the security processor unit is itself protected against manipulation and attacks.

The thus specifically secured security processor unit monitors whether the different processes carried out by the processor unit are carried out according to certain process criteria. These process criteria characterize in particular a regular, error-free operation of the arithmetic unit. If one of the processes carried out by the processor unit is not carried out according to these process criteria, this is an indication that the arithmetic unit has been attacked or manipulated. This is in particular an indication that an attacker has manipulated this process and modified control parameters of the arithmetic unit, for example. In this way, the security processor unit recognizes an attack on or a manipulation of the arithmetic unit early and takes an appropriate safety measure in order to protect the arithmetic unit.

According to one preferred embodiment of the present invention, the processor unit is operated in a hypervisor mode. It is further preferred that different virtual systems or virtual machines are configured as processes in the processor unit in this hypervisor mode. The virtual systems or machines are thereby configured in particular by a so-called hypervisor. This hypervisor is in particular also a process carried out by the processor unit. The hypervisor may in particular also be a hardware expansion, which is operated in a privileged operating mode and carries out a switchover between the virtual systems or the virtual machines. In these different virtual systems or machines, the processor unit once again respectively carries out further different processes. On the one hand, different operating systems and/or different applications may be carried out respectively as processes in the different virtual systems or machines. One such application is, for example, a runnable software, for example, a control software.

As mentioned at the outset, a processor unit operated in a hypervisor mode has significant advantages. The existing physical resources of the processor unit may be divided among the virtual machines or systems and used by them together. Using a hypervisor mode, different processes may be carried out by one single processor unit separately and independently of one another.

However, a processor unit operated in a hypervisor mode also offers points of attacks and is thus vulnerable to attacks and manipulations. For example, the risk exists that the local memory of the processor unit may be modified, for example via a debug access or an external boot mode. Conventional monitoring and protection methods may thus be bypassed, in particular when these are implemented as software which is carried out by the processor unit itself.

Using the present invention or its embodiments, the processor unit, which is operated in the hypervisor mode, may be protected particularly efficiently against attacks and manipulation. Since the security processor unit and the processor unit possess dedicated physical resources which are independent of one another, the security processor unit itself is protected against manipulation and attacks. The security processor unit is therefore particularly suitable for monitoring the different processes which are carried out by the processor unit in the hypervisor mode, in particular when the security processor unit and the processor unit are integrated monolithically. The security processor unit is thus in particular implemented as a Hardware Security Module (HSM) of the processor unit in the hypervisor mode.

It is further preferred if the arithmetic unit is used in a motor vehicle, for example, as an engine control unit. The present invention is particularly suitable for a control unit of a motor vehicle whose processor unit is operated in the hypervisor mode. As explained at the outset, it may be advantageous to operate the processor unit of the control unit in the hypervisor mode. In the different virtual systems or machines in the hypervisor mode, in particular control commands for the motor vehicle are determined as processes and measured values are detected and evaluated. With the aid of the present invention, such a control unit of a motor vehicle may be secured particularly efficiently and thus a “know-how protection” may be ensured and “chip tuning” may be prevented.

Advantageously, the security processor unit monitors whether the processes carried out by the processor unit are authorized to be carried out. Processes which are authorized to be carried out are in this case processes which may be or are to be carried out by the processor unit in the course of the regular operation of the arithmetic unit. The process criteria thus describe in particular which processes are to be carried out during the regular operation of the arithmetic unit. If the processor unit carries out an unauthorized process, meaning a process which is not authorized to be carried out, the security processor unit carries out the safety measure.

Such an unauthorized process may be a malicious software of an attacker, for example. The security processor unit thus in particular carries out a first safety measure or monitoring of the arithmetic unit and checks whether undesired, unfamiliar and/or malicious processes are being carried out.

The security processor unit preferably monitors whether the processor unit is carrying out a certain process according to a certain process criterion. In the course of the regular operation of the arithmetic unit, such certain processes are to be carried out according to certain process criteria, for example, in a certain sequence. If such certain processes are not carried out according to these certain process criteria, this is an indication that the arithmetic unit has been attacked or manipulated.

The security processor unit thus in particular carries out a second safety measure or monitoring of the arithmetic unit and checks whether processes are carried out correctly according to prescribed rules.

Such a certain process criterion is preferred according to which the processor unit carries out the certain process in a certain time interval and/or angle interval of a rotating reference shaft (in the motor vehicle in particular the crankshaft) and/or according to which the processor unit carries out the certain process in the certain time interval and/or angle interval for a certain minimum number of times. If the certain process is, for example, not carried out every 10 ms or, for example, not at least once within a time interval of 10 ms, this is an indication of an attack or a manipulation of the arithmetic unit. Here, an angle interval relates in particular to crankshaft angles of a motor vehicle.

For example, such a certain process may be the determination of a control instruction or the detection of a measured value. For example in the automotive sector, such a certain process may be the determination of a fuel injection amount or the detection of a temperature measured value or a pressure measured value. In a motor vehicle such processes must be repeated in a fixed time interval or in a fixed angle interval of the crankshaft angle. The fuel injection amount must, for example, be determined at fixed angle values of the crankshaft angle; temperature measured values or pressure measured values are generally detected in predefined time intervals.

Preferably, the security processor unit monitors an operating time of the different processes carried out by the processor unit. A processor criterion is here in particular that the operating time of the different processes may respectively not exceed a certain maximum operating time and/or may not fall below a certain minimum operating time. If the operating time of a process exceeds or falls below a corresponding maximum or minimum operating time, this is an indication of an attack or a manipulation of the arithmetic unit and the security processor unit carries out the safety measure.

According to an advantageous specific embodiment of the present invention, the security processor unit respectively stores how often the processor unit carries out the different processes in a certain time interval and/or angle interval for the different processes carried out by the processor unit. The security processor unit stores this information in particular in a table. An individual identification number (ID number) is assigned in particular to each process. According to these ID numbers, the corresponding information of the individual processes are stored in the table. In particular the operating time of the different processes carried out by the processor unit is also stored. The security processor unit monitors, in particular based on this stored information, whether the different processes are carried out according to certain process criteria.

Preferably, the security processor unit compares this stored information against predefined information. The security processor unit compares in particular the created table against a predefined table. In these predefined pieces of information or in this predefined table it is stored which processes are to be carried out in which time intervals and/or angle intervals how often in the course of the regular operation of the arithmetic unit. The security processor unit thus monitors with this comparison whether the different processes carried out are carried out according to the certain process criteria. With this comparison it is on the one hand monitored whether certain processes, as explained above, are carried out according to certain process criteria (for example, at least once in a time interval.) On the other hand, it is hereby monitored whether the carried out processes are authorized to be carried out.

The security processor unit preferably prevents as a safety measure an additional carrying out of a corresponding process which is not carried out according to the certain process criteria. Furthermore, this corresponding process is in particular blocked. A renewed carrying out of this corresponding process is thus prevented. It is further preferred if the security processor unit carries out a reset of the processor unit and/or creates an error entry as a safety measure. One such error entry may, for example, be created in an EEPROM memory. Based on such an error entry a maintenance of the arithmetic unit, for example, may be carried out.

An arithmetic unit according to the present invention, such as a control unit of a motor vehicle or a microcontroller in a motor vehicle, is configured, in particular by programming, to carry out a method according to the present invention.

The implementation of the method in the form of software is also advantageous, since it entails very low costs, in particular when an executing arithmetic unit is also used for other tasks and is therefore present anyway. Suitable data media for providing the computer program are, in particular, diskettes, hard drives, flash memories, EEPROMs, CD-ROMs, DVDs, etc. A download of a program via computer networks (Internet, Intranet, etc.) is also possible.

Additional advantages and embodiments of the present invention arise from the description and the accompanying drawing.

It is understood that the features stated above and the features still to be explained below are usable not only in the particular combination specified but also in other combinations or alone without departing from the scope of the present invention.

The present invention is schematically illustrated in the drawing on the basis of exemplary embodiments and described in greater detail in the following with reference to the drawing.

### BRIEF DESCRIPTION OF THE DRAWINGS

FIG. 1 schematically shows one preferred embodiment of an arithmetic unit which is configured to carry out one preferred specific embodiment of a method according to the present invention.

FIG. 2 schematically shows a preferred specific embodiment of a method according to the present invention as a block diagram.

### DETAILED DESCRIPTION

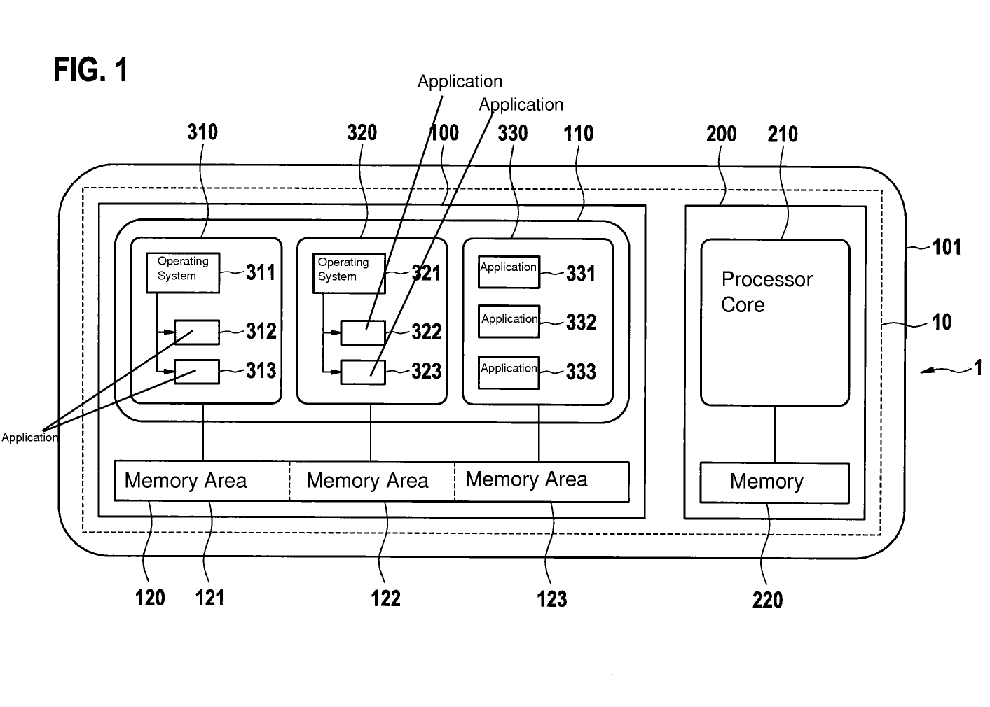

In FIG. 1, an arithmetic unit is shown in a highly simplified and schematic manner and denoted by reference numeral 1. In this example, the arithmetic unit is implemented as an engine control unit 1 of a motor vehicle which is configured to carry out an engine control of an internal combustion engine of the motor vehicle.

The control unit includes a monolithically integrated processor arrangement 10 including a processor unit 100 and a security processor unit 200. Processor unit 100 and security processor unit 200 are thus two independent individual processor units which are monolithically integrated on one shared die 101, i.e., on one shared (silicon) substrate.

Processor unit 100 includes a processor core 110 and a local memory 120, a RAM or a Flash memory, for example. Similarly, security processor unit 200 also has a processor core 210 and a local memory 220, for example a RAM or Flash memory.

Processor unit 100 is operated in a hypervisor mode. In this example, three virtual systems 310, 320, 330 are configured as processes in processor unit 100. Virtual systems 310, 320, 330 represent three independent systems which are simulated by processor unit 100.

The physical resources, such as flash memory 120, of processor unit 100 are here advantageously divided among the three virtual systems 310, 320, 330. The three virtual systems 310, 320, 330 are therefore shown in FIG. 1 as three parts of processor core 110 of processor unit 100. The division of flash memory 120 is indicated in FIG. 1 by a first memory area 121 of flash memory 120 being assigned to first virtual system 310, a second memory area 122 being assigned to second virtual system 320 and a third memory area 123 being assigned to third virtual system 330.

In first and second virtual system 310 and 320, one operating system 311 and 321 is respectively carried out as a process by processor unit 100. Furthermore, these operating systems 311 and 321 respectively carry out applications 312 and 313 or 322 and 323 as further processes of processor unit 100.

In the third virtual system 330, no operating system is carried out. Processor unit 100 directly carries out applications 331, 332, 333 as processes in third virtual system 330.

Such processes 312, 313, 322, 323, 331, 332, 333 which are carried out by first processor unit 100 are, for example, the detection of exhaust emission values of the internal combustion engine (for example, with the aid of a lambda sensor), the detection of a cooling water temperature of the internal combustion engine (for example, with the aid of a temperature sensor) or the determination of a fuel injection amount and a composition of a fuel-air mixture for the internal combustion engine.

Control unit 1 is furthermore configured to carry out one preferred specific embodiment of a method according to the present invention. Security processor unit 200 here monitors processes 312, 313, 322, 323, 331, 332, 333 carried out by processor unit 100.

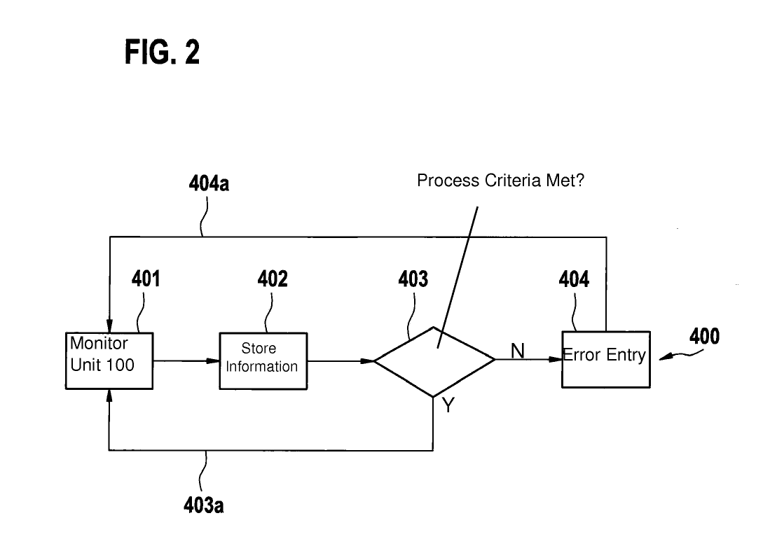

One preferred specific embodiment of a method according to the present invention is depicted schematically in FIG. 2 as a block diagram 400 and is described below as an example with reference to FIGS. 1 and 2.

In the following specific example, the case is considered that the security processor unit 200 monitors the two processes 322 and 331. In the course of process 322 the cooling water temperature, for example, is detected. In the course of process 331 the fuel injection amount, for example, is determined

In the course of the regular operation of control unit 1, the cooling water temperature is detected at fixed time intervals of 10 ms. The fuel injection amount is determined at fixedly predefined angle values of the crankshaft angle of the internal combustion engine, for example at a crankshaft angle of 90° KW.

A process criterion for process 322 is thus that processor unit 100 carries out process 322 at least once in a time interval of 10 ms. A process criterion for process 331 is thus that processor unit 100 carries out process 331 at an angle interval of 720° KW exactly at a crankshaft angle of 90° KW. These two pieces of information are stored in a corresponding predefined setpoint table.

In step 401, security processor unit 200 monitors how often processor unit 100 carries out process 322 and at which crankshaft angles processor unit 100 carries out process 331. Security processor unit 200 stores in step 402 this information ascertained in step 401 in an actual table.

Security processor unit 200 compares in step 403 the actual table against the setpoint table. Security processor unit 200 thus monitors whether processes 322 and 331 are carried out by processor unit 100 according to the certain process criteria.

If it is derived from the comparison that process 322 is carried out at least once in the time interval of 10 ms according to the corresponding process criterion and that process 331 is carried out according to the corresponding process criterion at the crankshaft angle of 90° KW, this indicates that control unit 1 has not been manipulated. Security processor unit 200 subsequently begins again with step 401, indicated by reference numeral 403a.

If, however, it is derived from the comparison that either process 322 has not been carried out at least once in the time interval of 10 ms and/or that process 331 was carried out at a crankshaft angle other than 90° KW, this indicates that control unit 1 has been manipulated.

Security processor unit 200 creates an error entry in step 404 and carries out a reset of processor unit 100. Security processor unit 200 subsequently begins again with step 401, indicated by reference numeral 404a.

If processor unit 100 carries out, for example, process 333 in addition to processes 322 and 331, security processor unit 200 also stores this piece of information in step 402 in the actual table. If it is derived from the comparison in step 403 that process 333 is not to be carried out, process 333 is an unauthorized process. This may indicate, for example, that control unit 1 has been manipulated.

Security processor unit 200 prevents in step 404 a further execution of process 333, creates an error entry and carries out a reset of processor unit 100.

It is noted that control unit 1 may also include multiple processor units 100 which may be designed similarly to processor unit 100. All such processor units 100 are monitored in a similar manner by security processor unit 200. Security processor unit 200 thus monitors all processes which are carried out by the individual processor units 100.

What is claimed is:

1. A method for monitoring an arithmetic unit having a monolithically integrated processor arrangement including a processor unit and a security processor unit, the processor unit and the security processor unit each including at least one processor core and a local memory, comprising:
carrying out, by the processor unit, different processes;
monitoring, by the security processor unit, whether the different processes carried out by processor unit are carried out according to certain process criteria; and
carrying out, by the security processor unit, a safety measure when one of the carried out processes is not carried out according to the certain process criteria.

2. The method as recited in claim 1, wherein the processor unit is operated in a hypervisor mode.

3. The method as recited in claim 2, further comprising:
configuring different virtual systems are configured in the processor unit as processes;
carrying out, by the processor unit, at least one of an operating system and an applications respectively as processes in the different virtual systems.

4. The method as recited in claim 1, wherein the security processor unit monitors as a process criterion whether the processes carried out by the processor unit are authorized to be carried out.

5. The method as recited in claim 1, wherein the security processor unit monitors as a process criterion at least one of:
whether the processor unit carries out the certain process within at least one of a certain time interval and an angle interval of a rotating reference shaft, and
whether the processor unit carries out the certain process for a certain minimum number of times in the at least one of the certain time interval and the angle interval of the rotating reference shaft.

6. The method as recited in claim 1, wherein the security processor unit monitors as a process criterion an operating time of the different processes carried out by the processor unit.

7. The method as recited in claim 1, wherein the security processor unit respectively stores for the different processes carried out by the processor unit how often the processor unit carries out the different processes in at least one of a certain time interval and an angle interval of a rotating reference shaft.

8. The method as recited in claim 7, wherein the security processor unit compares stored pieces of information against predefined pieces of information, and monitors whether the processes carried out by processor unit are authorized to be carried out.

9. The method as recited in claim 1, wherein the security processor unit at least one of:
prevents as a safety measure a further carrying out of the process which is not carried out according to the certain process criteria,
carries out a reset of the processor unit, and
creates an error entry.

10. The method as recited in claim 1, wherein the arithmetic unit is used in a motor vehicle.

11. An arithmetic unit having a monolithically integrated processor arrangement including a processor unit and a security processor unit, the processor unit and the security processor unit each including at least one processor core and a local memory, the arithmetic unit carrying out a method for monitoring the arithmetic unit, the method comprising:
carrying out, by the processor unit, different processes;
monitoring, by the security processor unit, whether the different processes carried out by processor unit are carried out according to certain process criteria; and
carrying out, by the security processor unit, a safety measure when one of the carried out processes is not carried out according to the certain process criteria.

12. A computer program which induces an arithmetic unit to carry out a method for monitoring the arithmetic unit, the arithmetic unit having a monolithically integrated processor arrangement including a processor unit and a security processor unit, the processor unit and the security processor unit each including at least one processor core and a local memory, the method comprising:
carrying out, by the processor unit, different processes;
monitoring, by the security processor unit, whether the different processes carried out by processor unit are carried out according to certain process criteria; and
carrying out, by the security processor unit, a safety measure when one of the carried out processes is not carried out according to the certain process criteria.

13. A machine-readable storage medium having stored therein a computer program which induces an arithmetic unit to carry out a method for monitoring the arithmetic unit, the arithmetic unit having a monolithically integrated processor arrangement including a processor unit and a security processor unit, the processor unit and the security processor unit each including at least one processor core and a local memory, the method comprising:
carrying out, by the processor unit, different processes;
monitoring, by the security processor unit, whether the different processes carried out by processor unit are carried out according to certain process criteria; and
carrying out, by the security processor unit, a safety measure when one of the carried out processes is not carried out according to the certain process criteria.
